(19) United States
(12) Patent Application Publication
(10) Pub. No.: US 2019/0002254 A1
(43) Pub. Date: Jan. 3, 2019

(54) WINCHES WITH AXIALLY ALIGNED, MECHANICALLY ACTUATED BRAKES, AND ASSOCIATED SYSTEMS AMD METHODS

(71) Applicant: Superwinch, LLC, Dayville, CT (US)

(72) Inventors: Ron Dennis, Woodburn, OR (US); Timothy Frazier, Beaverton, OR (US); Jacob August, Sherwood, OR (US); Brent Nasset, Salem, OR (US); Scott Salmon, Dayville, CT (US)

(21) Appl. No.: 15/640,091

(22) Filed: Jun. 30, 2017

(51) Int. Cl. B66D 1/22; F16H 1/28; F16H 57/10; F16D 55/46; F16D 63/00; F16D 59/00

(52) U.S. Cl. CPC B66D 1/22; F16H 1/28; F16H 57/10; F16D 2121/14; F16D 63/006; F16D 59/00; F16D 55/46

(57) ABSTRACT

Winches with axially aligned, mechanically actuated brakes, and associated systems and methods are disclosed. A representative winch includes a cable drum rotatable in a winding direction and an unwinding direction, a drive motor, a drive shaft coupled to the drive motor and rotatable about a shaft axis, a gear train coupled to the drive shaft and the cable drum, and a mechanically actuated brake. The brake can include a first element coupled to the drive shaft and rotatable about the shaft axis, a second element coupled to the cable drum and rotatable about the shaft axis, and a friction element positioned between the first and second elements and rotatable about the shaft axis. At least one of the first and second elements can be movable toward and away from the other between an engaged position with the friction element clamped between the first and second elements, and a disengaged position with the friction element unclamped.

### TECHNICAL FIELD

The present disclosure is directed generally to winches with axially aligned brakes, and associated systems and methods.

### BACKGROUND

Winches have been used for years in a variety of industries, including the automotive industry, and more particularly, the off-road vehicle industry. When used on off-road vehicles, winches can allow the vehicle operator to pull the vehicle out when it is stuck, guide the vehicle down a steep slope in a controlled manner, and/or move other vehicles or objects, depending upon the particular application.

FIGS. 1A and 1B illustrate a representative existing winch 10 having a motor 7 that drives a drum 1 via a transmission 20. The motor 7 receives power via power cables 96, and the drum 1 winds or unwinds a winch cable (not shown in FIG. 1A). The transmission 20 converts the relatively high speed, low torque output of the motor 7 to a low speed, high torque input for the drum 1. The winch 10 can include a spur gear 8 coupled to a disc brake 30a that operates to arrest the rotation of the drum 1. In operation, (referring now to FIG. 1B) pawls 44 ride along a brake disc 34, and engage notches 52 in the brake disc 34 to prevent the drum 1 from unwinding. The winch 10 includes a drum/motor axis 94 about which the drum 1 and motor 7 rotate, and a brake center line 95 which is offset from the drum/motor axis 94. As a result, the envelope of the winch housing includes a bulge 9 to accommodate the brake 30a.

FIG. 1C illustrates another existing brake 30c that operates electromagnetically. The brake 30c includes a rotating disc 81, one or more stationary discs 82, and an electromagnetic actuator 87 powered via an actuator cable 88. When activated, the electromagnetic actuator 87 moves a pressure plate 83 to the left to disengage the stationary disc 82 and the rotating disc 81. The actuator 87 can be carried in a coil housing 85 that forms part of an overall housing 42. The housing 42 can include a motor support plate 80 that supports a corresponding motor (not shown in FIG. 1C), which is coupled to a motor coupling 86. A spring 84 provides a restoring force against the pressure plate 83 so that when the electromagnetic actuator 87 is not actuated, the rotating disc 81 and stationary disc 82 are engaged.

FIG. 1D illustrates another existing brake 30d that operates hydraulically. Accordingly, the brake 30d can include one or more stationary discs 82, one or more rotating discs 81, and a pressure plate or piston 83. The pressure plate 83 is biased to engage the rotating and stationary discs 81, 82 via a disc spring 89. A hydraulic fluid port 91 provides hydraulic fluid that, when introduced at high pressure, drives the pressure plate 83 to the left to disengage the rotating and stationary discs 81, 82. The discs 81, 82 can be carried in a brake housing 42 that includes seals 93 to prevent the escape of hydraulic fluid.

While the forgoing designs are generally operable for their intended purposes, they may suffer from one or more drawbacks that are described in further detail later.

### BRIEF DESCRIPTION OF THE DRAWINGS

FIGS. 1A-1D illustrate existing winch brakes in accordance with the prior art.

FIG. 2 is a partially schematic, isometric illustration of a winch configured in accordance with some embodiments of the present technology.

FIG. 3 is a partially schematic, side elevation view of a winch transmission and brake configured in accordance with some embodiments of the present technology.

FIG. 4 is a partially schematic, cut-away illustration of a representative winch transmission and brake configured in accordance with some embodiments of the present technology.

FIG. 5 is a partially schematic, side elevation view of a winch brake configured in accordance with some embodiments of the present technology.

FIG. 6 is a partially schematic, exploded view of a winch configured in accordance with some embodiments of the present technology.

FIG. 7 is a partially schematic, exploded view of a winch brake having cammed surfaces in accordance with embodiments of the present technology.

### DETAILED DESCRIPTION

Embodiments of the present technology are directed generally to winches with axially aligned brakes, and associated systems and methods. In particular embodiments, winches having one or more of the features described herein can provide several advantages over existing winches. For example, the winches can provide a more compact shape that can provide for functional and/or aesthetic benefits. Brakes in accordance with particular embodiments of the present technology can be coupled to winches at a variety of suitable points, including directly adjacent a winch motor, and/or at one or more positions in the winch transmission. Embodiments of the winch can be particularly configured to avoid engaging the brake unnecessarily, which can wear out the brake, and/or create unnecessary heat in the environment in which the brake operates.

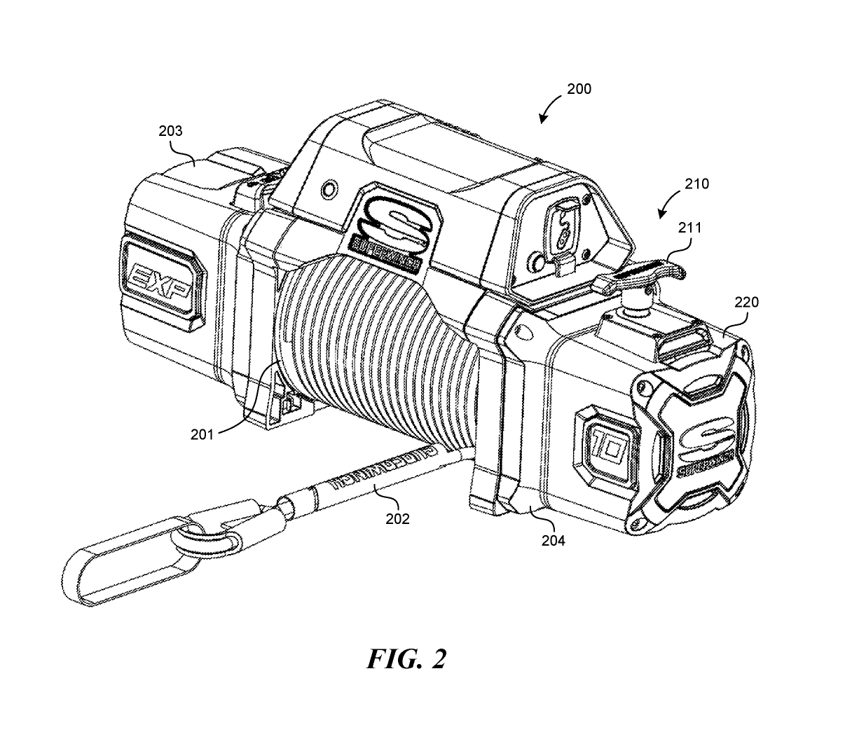

Several details describing structures and/or processes that are well-known and often associated with winches, but that may unnecessarily obscure some significant aspects of the present technology, are not set forth in the following description for purposes of clarity. Moreover, although the following disclosure sets forth several embodiments of different aspects of the technology, several other embodiments of the technology can have different configurations and/or different components than those described in this section. As such, the technology may have other embodiments with additional elements, and/or without several of the elements described below with reference to FIGS. 2-7.

FIG. 2 is a partially schematic, isometric illustration of a winch 200 configured in accordance with some representative embodiments of the present technology. The winch 200 can include a drive motor 203 that powers a drum 201 carrying a winch cable 202. Accordingly, the drive motor 203 can wind the cable 202 on the drum 201, or allow the cable 202 to be unwound from the drum 201. The drive motor 203 operates through a transmission 220 that converts the relatively high-RPM, low torque output of the drive motor 203 to low-RPM, high torque power input for the drum 201. The winch 200 can further include a clutch 210 operable via a clutch handle 211, that the operator can selectively use to engage or disengage the drive motor 203 from the drum 201. A housing 204 protects the internal components of the winch 200.

During a normal winching operation, the drive motor 203 drives the drum 201 via the transmission 220. When the operator wishes to strip or unwind the cable 202 from the drum 201, the operator disengages the clutch 210 to allow the drum 201 to easily rotate in the opposite direction, without resistance provided by the transmission 220 or the drive motor 203.

In another mode of operation, the drive motor 203 can remain engaged with the drum 201 (via the transmission 220) while the cable 202 is unwound from the drum 201. This mode of operation can be used, for example, to back a vehicle down a steep slope, with a restraining force provided by the winch 200. During such operations (typically referred to as “powering out”), it is desirable to provide a braking force without unnecessarily wearing the brake. Suitable techniques for this operation are described further later.

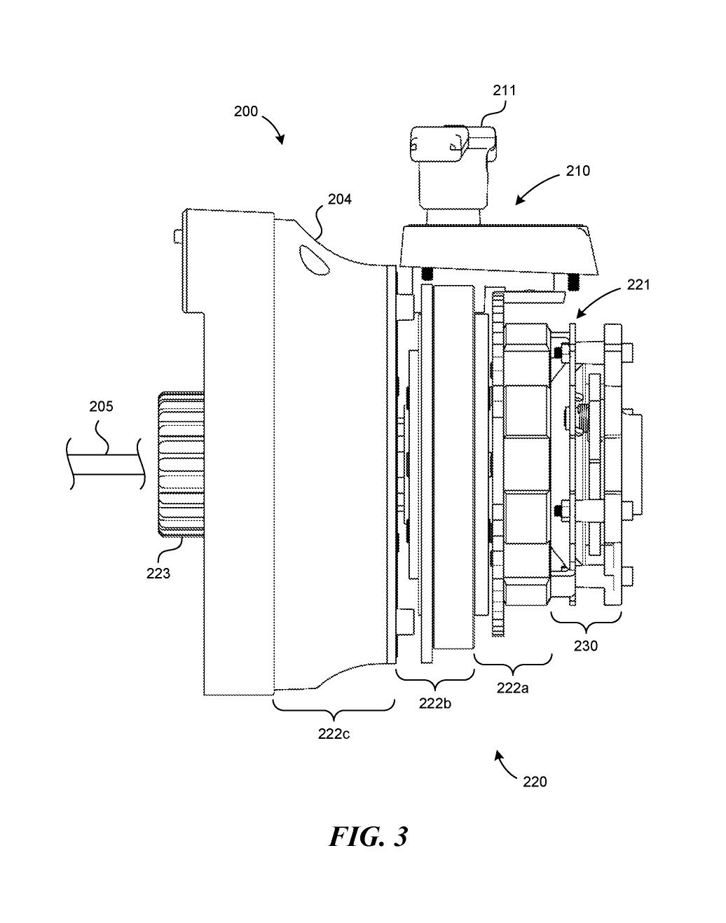

FIG. 3 is a partially schematic illustration of a portion of the winch 200 shown in FIG. 2, with a portion of the housing 204 removed. As shown in FIG. 3, a motor shaft 205 is connected to the transmission 220 to provide input power. The output of the transmission 220 is provided via an output shaft gear 223 located and rotatable concentrically relative to the motor shaft 205. The output shaft gear 223 includes external threads that engage with corresponding internal threads of the drum 201 (FIG. 2).

In a particular embodiment, the transmission 220 includes a gear train 221 that in turn includes a multi-stage planetary gear arrangement. In some embodiments, the gear train 221 can include a first stage 222a, a second stage 222b, and a third stage 222c. In a particular embodiment shown in FIG. 3, the winch 200 further includes a brake 230 operatively connected to the first stage 222a.

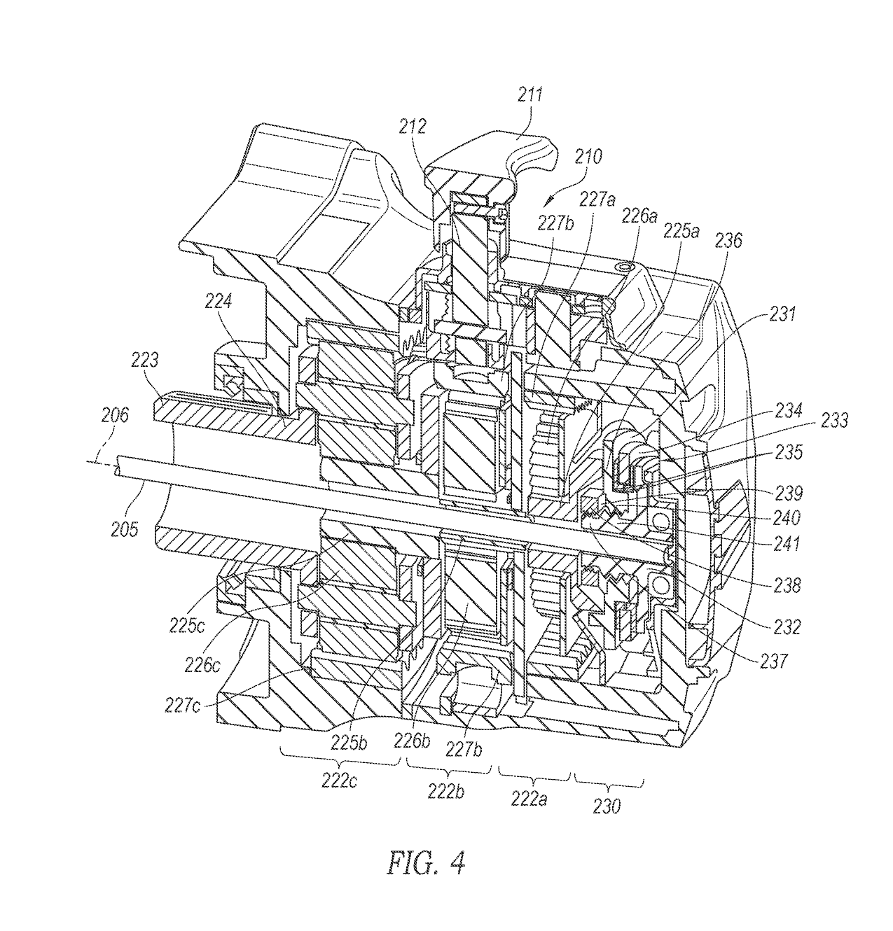

FIG. 4 is partially schematic, cut-away illustration of the portion of the winch described above with reference to FIG. 3. As shown in FIG. 4, the drive shaft 205 rotates about a shaft axis 206, and is connected to the brake 230. The brake 230 operates to transmit the rotary motion of the drive shaft 205 to the first stage 222a of the transmission, which in turn transfers rotary motion to the second stage 222b, which in turn transmits the rotary motion to the third stage 222c, which drives the output shaft 224 and output shaft gear 223. Accordingly, the brake 230 operates as a coupler between the motor 203 (FIG. 2) and the transmission 220, and the transmission 220 acts as a further coupler to the cable drum 201 (FIG. 2).

In representative embodiments, the planetary gear arrangement can produce a significant gear reduction, e.g., about 155:1. Each of the planetary gears stages 222a, 222b, 222c can include a corresponding sun gear 225a, 225b, 225c, corresponding planet gears 226a, 226b, 226c, and a corresponding ring gear 227a, 227b, 227c. When the clutch 210 is engaged, a clutch shaft 212 engages with the second stage ring gear 227b, thus grounding the second stage ring gear 227b and allowing the rotary motion of the drive shaft 205 to be transmitted to the output shaft 224 via the transmission 220. When the clutch shaft 212 is disengaged from the second stage ring gear 227b, the output shaft 224 (and therefore the drum 201, shown in FIG. 2) can spin freely relative to the motor drive shaft 205.

As shown in FIG. 4, the drive shaft 205 drives the output shaft 224 via the brake 230. Accordingly, the brake 230 can include a first element 231 (e.g., a brake grip), a second element 232 (e.g., a brake driver), and a friction element 233 positioned between the first and second elements 231, 232. The friction element 233 can include one or more discs 234 (one is shown in FIG. 4) and one or more pads 235 (two are shown in FIG. 4) that provide a releasable, frictional interface between the first element 231 and the second element 232.

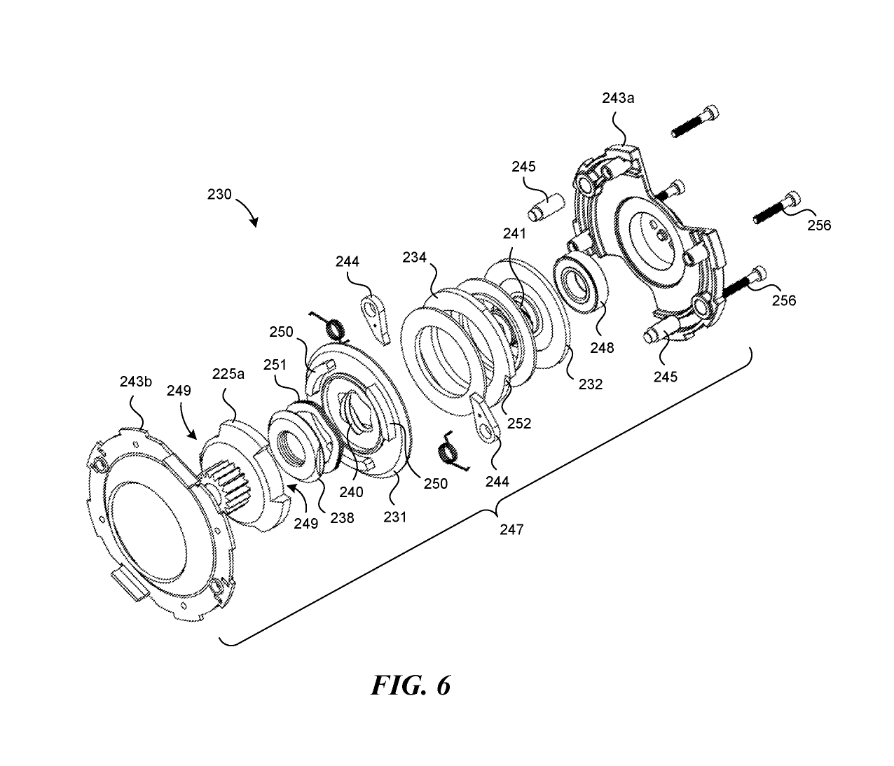

The first element 231 is journaled to the first sun gear 225a, and the second element 232 is fixed to the drive shaft 205. Accordingly, when the brake 230 is engaged, with the friction element 233 clamped between the first element 231 and the second element 232, the drive shaft 205 drives the first stage sun gear 225a. The first element 231 includes first element threads 240 that threadably engage with second element threads 241 carried by the second element 232. Accordingly, relative rotary motion between the first and second elements 231, 232 in one direction causes the first element to clamp the friction element 233 to the second element 232, and relative rotary motion in the opposite direction causes the first element 231 to unclamp the friction element 233. When the brake 230 is disengaged, the friction element 233 can be supported on a shoulder 236 of the first element 231. The second element 232 can include retention threads 237 that threadably engage a retention nut 238 to prevent the first element 231 from moving too far to the left, as shown in FIG. 4. A wave washer gap 239 is positioned between the retention nut 238 and the first element 231 and houses a wave washer (described later with reference to FIG. 6) that prevents the first element 231 from threadably locking against the retention nut 238.

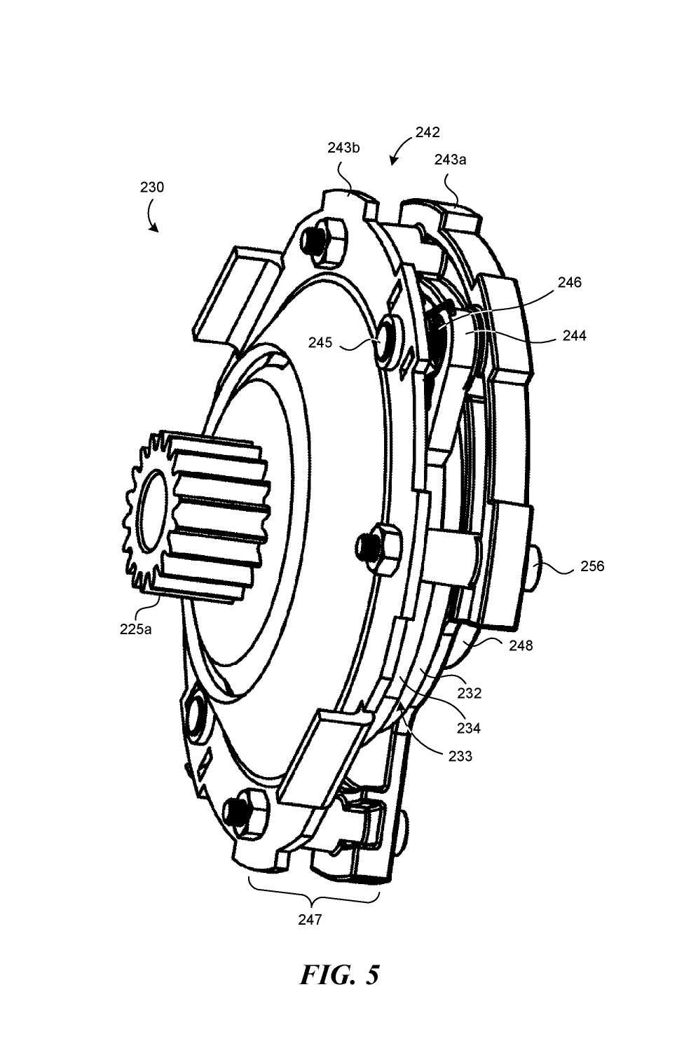

The brake 230 can further include a locking element that selectively engages the brake disc 234. For example, the locking element can include pawls (described further below with reference to FIGS. 5 and 6) that contact the outer rim of the brake disc 234. When the drive motor 203 (FIG. 2) and the drive shaft 205 rotate in a winding direction, e.g. to wind the winch cable onto the drum 201 (FIG. 2), the pawls ride along the outer edge of the brake disc 234 without engaging it. When the drive motor 203 and drive shaft 205 stop, the load on the winch cable will tend to rotate the motor 203 in the opposite direction. When this happens, the pawls engage with the brake disc 234, and, because the brake 230 is in its engaged configuration, the output shaft 224 and the drum 201 stop rotating.

If the operator then “powers out” by driving the winched vehicle away from the winch anchor point, while the clutch 210 is engaged, and the motor 203 is powered and rotating in the reverse direction, the first element 231 (which is coupled to the drum) is allowed to rotate relative to the second element 232 (which is coupled to the motor) to unclamp the friction element 233. If the drum turns too fast relative to the motor, the difference in rotation rate between the first element 231 and the second element 232 causes the first element 231 to again clamp the friction element 233 against the second element 232. In this manner, the brake 230 effectively governs the rate at which the winched load (e.g., the vehicle) can be powered out.

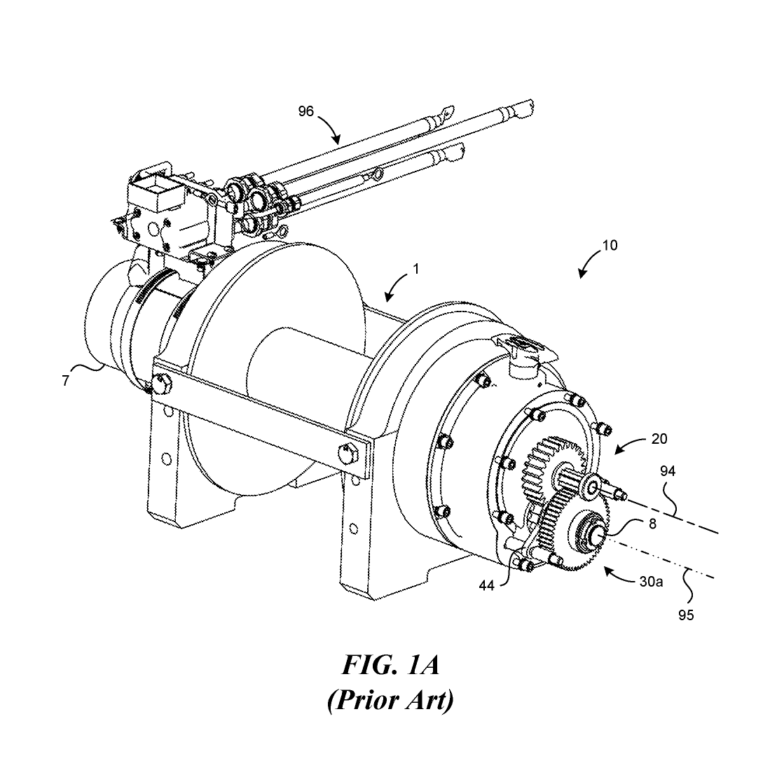

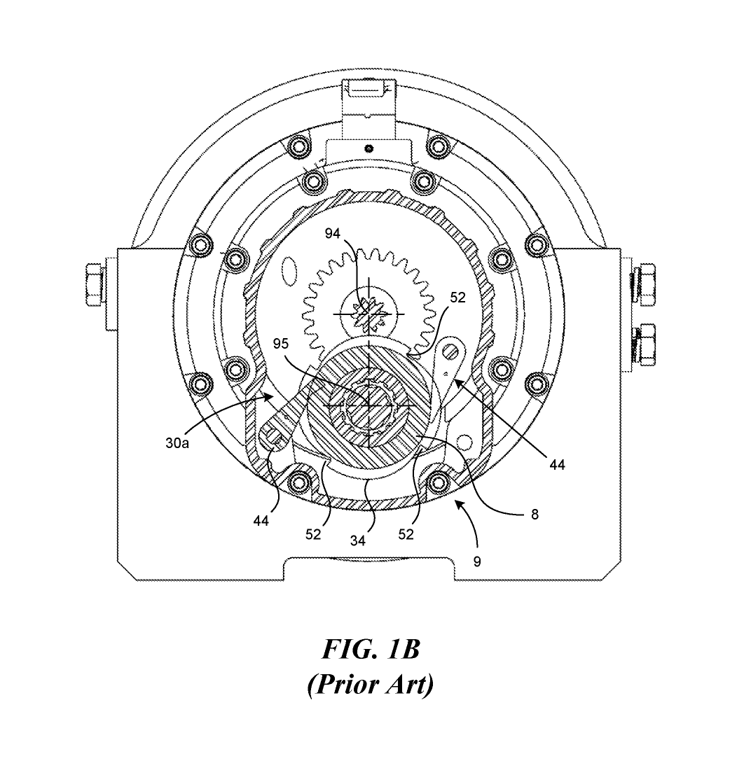

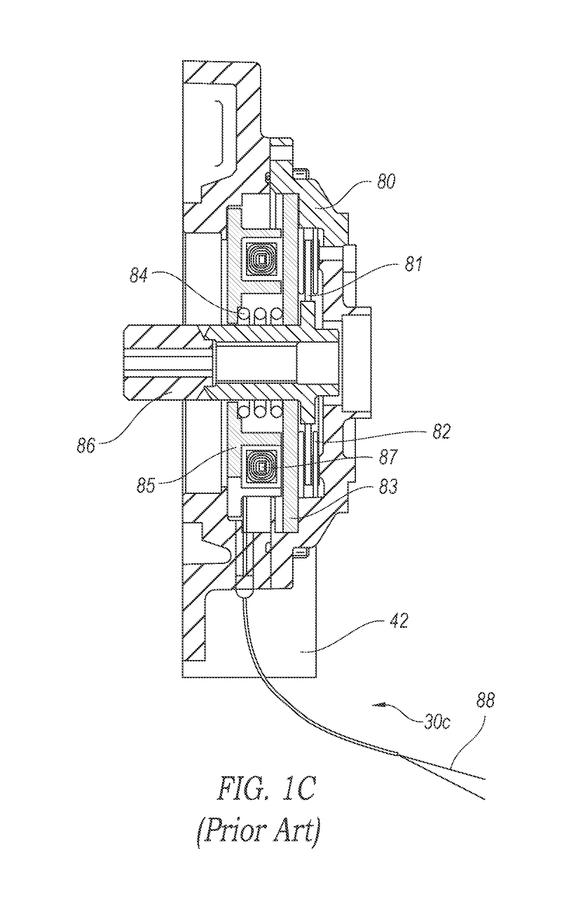

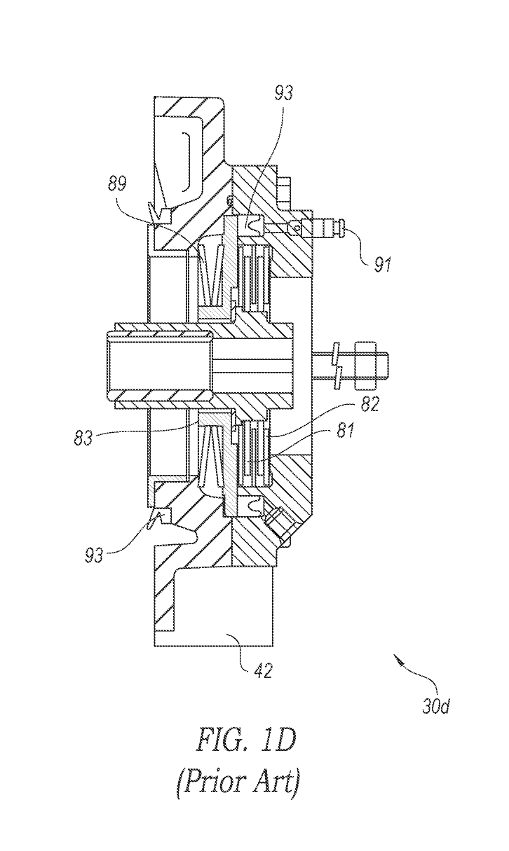

During the foregoing process, the brake 230 periodically engages and disengages to prevent excessive drum speed, but is consistently either engaged or disengaged. This is unlike some conventional braking arrangements in which the brake is continuously engaged, but is overdriven so that it is constantly slipping and wearing, which creates excessive heat and brake wear. In some instances, a brake used in this continuously engaged fashion can become glazed, which can effectively eliminate the effectiveness of the brake for any operation—not just powering out, but also simply holding the winched load in place. Accordingly, brakes operating in accordance with embodiments of the present technology can provide one or more significant advantages over existing brakes, including reduced brake wear, increased brake life, and increased brake effectiveness. In addition, the axis about which the brake 230 operates is the same as the shaft axis 206. Accordingly, the brake 230 can have a minimal impact on the overall envelope or shape of the winch. In particular, this approach can reduce or eliminate the bulge 9 described above with reference to FIG. 1B. Still further, in an embodiment shown in FIG. 4, the brake 230 can be connected to the first stage 222a of the transmission 220, which can allow the brake to be easily accessed and removed, if necessary, for maintenance, service, and/or repair. Further details of this operation are described below with reference to FIG. 5.

FIG. 5 is a partially schematic, isometric illustration of the brake 230 shown in FIG. 4. The brake 230 can include a housing 242 that in turn includes a first housing member 243a and a second housing member 243b connected with fasteners 256. The first element 231 (not visible in FIG. 5), second element 232, and friction member 233 can be carried between the first and second housing members 243a, 243b. As is also shown in FIG. 5, the housing 242 can carry one or more pivotable pawls 244 that ride along the outer edge of the brake disc 234. As described above, the pawls 244 allow the brake disc 234 to rotate in one direction, and prevent the brake disc 234 from rotating in the opposite direction. The brake 230 can further include a bearing 248 positioned toward the right end of the brake 230 to facilitate smooth rotary operation of the brake elements.

The brake 230 can form a sub assembly 247 (e.g., a packet or cassette) that is specifically configured for easy removal from the winch. For example, the first housing member 243a, the bearing 248, the second element 232, the friction element 233, the first element 231, the pawls 244 and associated pawl pins 245 and pawls springs 246, the second housing member 243b and the first stage sun gear 255a can be removed, e.g., as a single unit. The ability to remove the foregoing elements as a unit can improve serviceability of the winch 200. In the event that the brake 230 is permanently removed and not replaced, the first stage sun gear 255a (or other connecting element) will typically be replaced with another suitable connecting element because the brake 230 forms the connection between the motor shaft and the transmission.

FIG. 6 is a partially schematic, exploded illustration of the components of the brake 230, and in particular, of the sub assembly 247. As shown in FIG. 6, the first element 231 can include tabs or splines 250 that fit into corresponding slots or grooves 249 carried by the first stage sun gear 225a. Accordingly, the first element 231 can slide axially relative to the first stage sun gear 225a, while still transmitting rotary motion to or from the first stage sun gear 225a. FIG. 6 is also illustrates the brake disc 234, with a corresponding notch 252 visible. When the brake disc 234 rotates counterclockwise relative to the fixed second housing member 243b, the pawls 244 ride on the outer rim or edge of the brake disc 234 and do not (significantly) impinge on the ability of the brake disc 234 to rotate. When the brake disc 234 rotates counterclockwise, the pawls 244 engage with the notches 252 to prevent further rotation. As a result of the significant gear reduction between the brake disc 234 and the cable drum 201 (FIG. 2), if the brake disc 234 rotates 180° before the pawls 244 engage the corresponding notches 252, the drum 201 (FIG. 2) will rotate only slightly (e.g., 1°-3°). Accordingly, the brake 230 can quickly arrest the unwinding motion of the drum 201, e.g., when the motor stops.

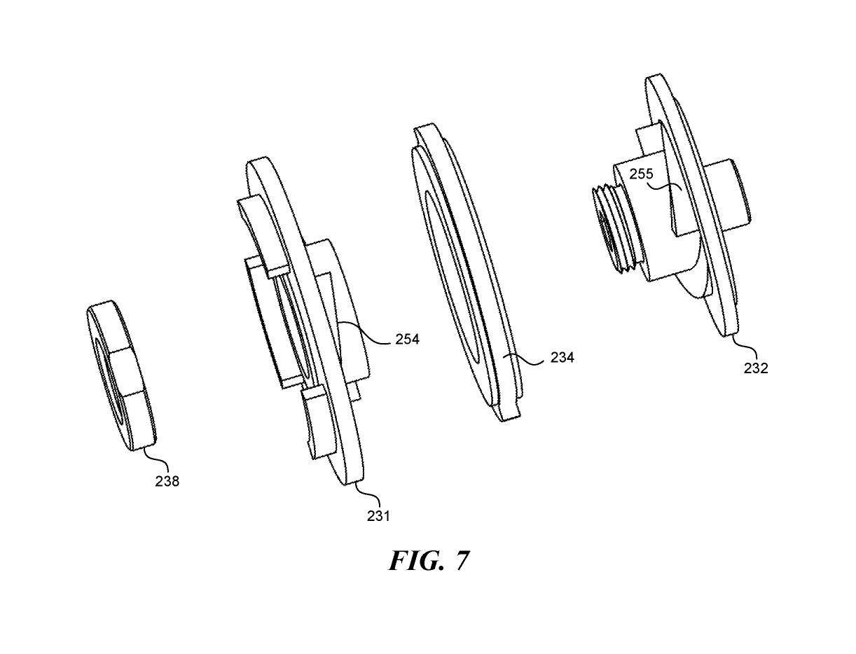

As is also shown in FIG. 6, the first element 231 includes first element threads 240 (e.g. internal threads) that threadably engage with the second threads 241 (e.g. external threads) carried by the second element 232. In other embodiments, other arrangements can be used to guide the relative motion between the first element 231 and the second element 232, as described further below with reference to FIG. 7.

FIG. 7 is partially schematic, exploded illustration of a cam arrangement for guiding the relative motion between the first element 231 and the second element 232. The first element 231 can include a first cam surface 254 (on the backside of the first element 231 as it appears in FIG. 7), and the second element 232 can include a second cam surface 255 that is engaged with the first cam surface 254. When the first element 231 and second element 232 rotate relative to each other in a first direction, the cam surfaces 254, 255 drive the two elements 231, 232 apart from each other, and when they rotate in the opposite direction, the cam surfaces 254, 255 cause the two elements 231, 232 to move toward each other. Accordingly, the operation of the brake can proceed as described above, with the cam surfaces 254, 255 performing functions similar or identical to those performed by the internal threads 240 and the external threads 241 described above with reference to FIG. 6.

One feature of at least some of the foregoing embodiments is that the brake operates automatically via mechanical actuation. That is, the brake automatically engages or disengages in the manner described above, without the need for a separate actuator, such as an electric actuator or a hydraulic actuator. Instead, the mechanical forces provided by the winch and the brake elements during a winching operation and a power-out operation automatically engage and disengage the brake.

Another feature of at least some of the foregoing embodiments is that the brake operates in a binary manner between an engaged configuration and disengaged configuration. This feature can reduce or eliminate the likelihood for excessive wear on the brake, e.g., because it is less wearing to fully engage and fully disengage the brake (with little or no relative movement between the brake pads and the first and second brake elements when engaged) than it is to partially engage the brake (while the first and second elements slip relative to each other and wear the brake pads). This operation can have particular utility during a power-out operation, as discussed above. In at least some embodiments, the bulk of the task of braking the vehicle during a power-out operation can be performed by the vehicle's brakes, which are more suited to such a task than are the relatively smaller brakes of a typical vehicle winch.

Another feature of at least some of the foregoing embodiments is that the brake is axially aligned with the motor drive shaft. An advantage of this arrangement is that it can reduce the number of components required by the brake (e.g., by eliminating the need for an off-axis spur gear). Another advantage is that the overall winch can be made more compact and uniform, which can reduce the amount of space occupied by the winch, and/or can provide a cleaner looking product.

Another feature of at least some of the foregoing embodiments is that the brake is positioned external to the cable drum. An advantage of this arrangement is that it is less likely to heat the drum. Another advantage is that the brake can be more easily accessed for maintenance, repair, and/or replacement.

From the foregoing, it will be appreciated that specific embodiments of the disclosed technology have been described herein for purposes of illustration, but that various modifications may be made without deviating from the technology. For example, the brake can be coupled to the first stage of a multi-stage planetary gear transmission (as shown in FIGS. 4 and 5), or to other stages of the transmission. In further embodiments, the brake can be applied to the motor shaft on the opposite side of the motor as that shown in FIG. 2. That is, the motor shaft can extend entirely through the motor, with one end of the shaft connected to the transmission, and the other connected to the brake. In still further embodiments, the brake can be connected anywhere along the motor axis to operate in a generally similar manner. While threads and cams were described above for drawing the brake elements toward and away from each other, in some embodiments the brake can include other mechanically actuated arrangements.

Certain aspects of the technology described in the context of particular embodiments maybe combined or eliminated in other embodiments. For example, one or more of the planetary gear stages can be eliminated in some embodiments. In some embodiments, the brake can be connected to a different stage of the transmission (e.g., the second stage) where rotational velocities and associated forces (e.g., centrifugal forces) are lower. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the present disclosure in the associated technology can encompass other embodiments not expressly shown or described herein.

I/We claim:

1. A winch, comprising
a cable drum rotatable in a winding direction and an unwinding direction;
a drive motor;
a drive shaft coupled to the drive motor and rotatable about a shaft axis;
a gear train coupled to the drive shaft and the cable drum; and
a mechanically actuated brake having a first element coupled to the drive shaft and rotatable about the shaft axis, a second element coupled to the cable drum and rotatable about the shaft axis, and a friction element positioned between the first and second elements and rotatable about the shaft axis, wherein at least one of the first and second elements is movable toward and away from the other between an engaged position with the friction element clamped between the first and second elements, and a disengaged position with the friction element unclamped.

2. The winch of claim 1 wherein:
the friction element includes a brake disc having at least one pawl notch; and
wherein the winch further comprises:
at least one pawl that is pivotable relative to the brake disc and positioned to allow rotation of the brake disc in a first direction and prevent rotation of the brake disc in a second direction opposite the first direction.

3. The winch of claim 1, further comprising a brake housing, and wherein:
the gear train includes a sun gear;
the first element includes a brake grip positioned within the housing and slideably journaled to the sun gear to rotate with the sun gear and slide axially relative to the sun gear, the brake grip having internal threads;
the second element includes a brake driver positioned within the housing and connected to the drive shaft to rotate with the drive shaft, the brake driver having external threads threadably engaged with the internal threads of the brake grip; and
the friction element includes a brake disc positioned within the brake housing between the brake grip and the brake driver, the friction element further including a first disc pad facing toward the brake grip and a second disc pad facing toward the brake driver, the brake disc further having at least one pawl notch; and wherein the winch further comprises:
at least one pawl pivotably coupled to the brake housing and positioned to allow rotation of the brake disc in a first direction and prevent rotation of the brake disc in a second direction opposite the first direction.

4. The winch of claim 1 wherein the mechanically actuated brake is positioned external to the cable drum.

5. The winch of claim 1 wherein the gear train includes multiple planetary gear stages, and wherein the mechanically actuated brake is driven by at least one of the planetary stages.

6. The winch of claim 1 wherein the gear train includes a sun gear, and wherein the first element is slideably engaged with the sun gear, and wherein first element, the second element and the friction element are all axially removable from the winch along the shaft axis.

7. The winch of claim 6 wherein first element, the second element and the friction element form a subassembly and are all axially removable from the winch as a unit along the shaft axis.

8. The winch of claim 1 wherein the first and second elements are threadably engaged with each other.

9. The winch of claim 1 wherein the first and second elements are engaged with each other via corresponding cam surfaces.

10. The winch of claim 1 wherein at least one of the first and second elements is positioned to move toward and away from the other as a result of differences in rotational velocity between the first and second elements.

11. A brake for a winch, the winch having a drive shaft rotatable about a drive shaft axis, the brake comprising:
a first rotatable element positionable to align co-axially with the shaft axis;
a second rotatable element aligned co-axially with the first element;
a friction element positioned between, and aligned co-axially with, the first and second elements, wherein at least one of the first and second elements is movable toward and away from the other between an engaged position with the friction element clamped between the first and second elements, and a disengaged position with the friction element unclamped; and
a locking element positioned to allow rotation of the friction element in a first rotational direction and prevent rotation of the friction element in a second rotational direction opposite the first rotational direction.

12. The brake of claim 11, further comprising a brake housing carrying the first rotatable element, the second rotatable element, the friction element, and the locking element.

13. The brake of claim 11 wherein the locking element includes a pawl that is pivotable relative to the friction element.

14. The brake of claim 11 wherein the winch includes a sun gear, and wherein the first rotatable element is slideably engagable with the sun gear.

15. The brake of claim 11 wherein the first and second elements are threadably engaged with each other.

16. The brake of claim 11 wherein the first and second elements are engaged with each other via corresponding cam surfaces.

17. The brake of claim 11 wherein at least one of the first and second elements is positioned to move toward and away from the other as a result of differences in rotational velocity between the first and second elements.

18. A method for operating a winch, comprising:
winding a winch cable onto a cable drum by driving a motor in a first rotational direction, the motor having a motor shaft and an engaged gear train coupled between the motor shaft and the cable drum;
unwinding the winch cable off the cable drum, while the gear train between the motor shaft and the cable drum is engaged, with the motor rotating in a second rotational direction opposite the first rotational direction; and
slowing or halting the winch cable from unwinding only when a rotational speed of a first element of a brake, coupled to the cable drum, exceeds a rotational speed of a second element of the brake, coupled to the motor shaft, causing the first and second elements to clamp a friction element therebetween while at least one of the first second elements is stopped from rotating, and while the first element, the second element and the friction element are aligned along a rotation axis of the motor shaft.

19. The method of claim 18, further comprising operating a clutch to disengage the cable drum from the motor, and unwinding the winch cable off the cable drum without rotating the motor.

20. The method of claim 18 wherein at least one of the first and second elements threadably rotates toward the other to clamp the friction element.

21. The method of claim 18 wherein at least one of the first and second elements rotates a cam surface relative to the other to clamp the friction element.

22. The method of claim 18, further comprising removing the first element, the second element, and the friction element, as a unit, from the winch.
